(19) United States
(12) Patent Application Publication
(10) Pub. No.: US 2018/0151047 A1
(43) Pub. Date: May 31, 2018

(54) METHOD AND SYSTEM FOR WEARABLE PERSONNEL MONITORING

(71) Applicant: REI, Inc., Salt Lake City, UT (US)

(72) Inventors: Daniel J. BRUNNER, Salt Lake City, UT (US); Randy RICHARDSON, South Jordan, UT (US); Robert KOONTZ, Herriman, UT (US)

(73) Assignee: REI, Inc., Salt Lake City, UT (US)

(21) Appl. No.: 15/642,636

(22) Filed: Jul. 6, 2017

Related U.S. Application Data
(60) Provisional application No. 62/450,157, filed on Jan. 25, 2017.
(60) Provisional application No. 62/360,815, filed on Jul. 11, 2016.

(51) Int. Cl. G08B 21/02

(52) U.S. Cl. CPC G08B 21/02

(57) ABSTRACT

A system that includes a sensor. The sensor includes an electrode embedded in a wearable garment, a first transmitter, and a processing unit. The processing unit includes a receiver that receives information from the first transmitter relating to at least one of a physiological and an environmental condition of an individual wearing the garment. The processing unit includes a second transmitter that provides the information to a central monitoring location.

### CROSS-REFERENCE TO RELATED APPLICATIONS

The present application claims priority to U.S. Provisional Application No. 62/360,815 and U.S. Provisional Patent Application No. 62/450,157. U.S. Provisional Application No. 62/360,815 and U.S. Provisional Patent Application No. 62/450,157 are each incorporated herein by reference.

### TECHNICAL FIELD

The present disclosure relates generally to method of and system for personal monitoring incorporating wearable sensors and, more particularly, but not by way of limitation, to wearable sensor-based networked systems for physiological and environmental monitoring of individuals and K9 units working in harsh working environments.

### BACKGROUND

Individuals working in, for example, construction, mining, oil, and gas, and chemical plants, are exposed to rigorous and hazardous environments where they are exposed to heat (in various forms, radiant and direct), UV, gasses and vapors, high temperature equipment, and potentially explosive conditions. Due to changes in demographics, generational culture, economic cycles, economic conditions, advances in medicine, and increases in life-expectancy, the work-force in these industries is Heavy Industry Personnel that are of the Baby Boomer generation, continue to work in Heavy Industry for various reasons including financial needs as well as the needs of industry. For example, in the coal mining industry, there is a significant statistical gap in ages of members of the work force. It has been said that an entire generation (X) is not represented. This may be due to the disfavor of coal and mining from an environmental perspective and economic conditions during the time of career planning. In the coal mining industry, experienced and knowledgeable personnel working underground, operating coal cutting, transfer, and haulage equipment, supervising mining sections, or mines, and managing mining operations are indispensable and necessary to mentor and train the younger generation (Y). Many Baby Boomers that are working in Heavy Industry suffer from age related physiological issues that do not necessarily limit their activity and ability to work, but that can be exacerbated fairly quickly by the working environment and physical activity. The oil industry is facing similar generational challenges (“Great Crew Change”). Health conditions like diabetes, heart issues (irregular, atrial fibrillation, etc.) and respiratory limitations can be easily controlled and managed in a white collar work environment but raise concerns in Heavy Industry.

Additionally, K9 units are specifically trained to assist police and other law-enforcement as well as military personnel in their work. Their duties include searching for drugs, explosives, lost people, crime scene evidence, and protecting their handlers. Canine units have become the best tool available for organizations such as, for example, US Border Patrol. The success of highly trained canine units used in law enforcement, combat, detection of chemicals, explosives, narcotics, and other contraband requires a strong interface between the canine and its handler.

Deployment of canine units in rugged and hazardous situations often require remote communication with the canine, weakening the canine/handler interface. There is a need for the handler to have an ability to monitor, for example, canine vitals, activity, and location using a remote communication system that can be quickly deployed. if the handler is able to simultaneously monitor all of this data in real time from a remote location, the efficiency and safety of the canine units would be greatly improved.

### SUMMARY OF THE INVENTION

The present disclosure relates generally to method of and system for personal monitoring incorporating wearable sensors and, more particularly, but not by way of limitation, to wearable sensor-based networked systems for physiological and environmental monitoring of individuals and K9 units working in harsh working environments. In one aspect, the disclosure relates to a system that includes a sensor. The sensor includes an electrode embedded in a wearable garment, a first transmitter, and a processing unit. The processing unit includes a receiver that receives information from the first transmitter relating to at least one of a physiological and an environmental condition of an individual wearing the garment. The processing unit includes a second transmitter that provides the information to a central monitoring location

### BRIEF DESCRIPTION OF THE DRAWINGS

For a more complete understanding of the present disclosure and for further objects and advantages thereof, reference may now he had to the following description taken in conjunction with the accompanying drawings in which:

FIG. 1A is a schematic diagram of a conventional 4-lead continuous heart-rate monitor;

FIG. 1B is a schematic diagram of an illustrative wearable personnel monitoring system;

FIG. 1C is a schematic diagram of an illustrative remote dual antenna system with recessed reflectors;

FIG. 2 is a schematic diagram illustrating placement of two electrodes;

FIG. 3 is a schematic diagram illustrating placement of electrodes or micro-acoustic sensors in a hard hat;

FIG. 4 is a schematic diagram illustrating placement of physiological sensors in a wearable vest;

FIG. 5 is a schematic diagram illustrating various sensors for environmental monitoring;

FIG. 6 is a schematic diagram illustrating another embodiment for placement of sensors for environmental monitoring;

FIG. 7 is a schematic diagram of an illustrative physiological and environmental monitoring system for a K9 unit; and

FIG. 8 is a schematic diagram illustrating K9 units acting as mesh clients in a wireless mesh network.

### DETAILED DESCRIPTION

Various embodiments will now be described more fully with reference to the accompanying drawings. The disclosure may, however, be embodied in many different forms and should not be construed as limited to the embodiments set forth herein.

Exemplary embodiments disclose a wearable sensor based networked system that monitors the health and safety of individuals and the environment that they are exposed to in Heavy Industry (Wearable Personnel Monitoring System (“WPMS”). The WPMS is also applicable for individuals working in isolation, remotely and/or on long shifts, for example, equipment operators, drivers, truck drivers, train drivers, public transportation drivers, pilots, operators of any equipment, and the like. Exemplary embodiments of the system includes an ability to transmit collected sensory information along with tracking, locating, and monitoring location of individuals, including proximity (and warning) of individuals to heavy equipment and hazardous locations. In a typical embodiments, the wearable sensors comprise sensors disclosed below:

### Environmental Sensors

| | |
|---|---|
| Noise | Explosive Gases |
| Temperature | Dust |
| Radiation | Location |
| Vibration | Proximity to Equipment |
| Hazardous Gases | Proximity to Hazards |

### Physiological Sensors

| | |
|---|---|
| Heart Rate | Respiratory Irregularities |
| Body Temperature | Fall or Impact |
| Body Surface Temperature | Hydration |
| Pulse Rate | Blood Sugar Levels |
| Respiratory Rate | Body Position |

In various embodiments, the sensors are mounted or attached to individuals working in Heavy Industry at various locations as disclosed below:

### Mounting of Sensors

| | |
|---|---|
| Imbedded in Work Coveralls | Imbedded in Hard Hats and |
| | Affixed to Body Surfaces by |
| | Tension from Hard Hat |
| | Suspension System |
| Imbedded in Reflective | On or imbedded in Vests, |
| Strips on Work Coveralls | Coveralls, or Reflective |
| | Fabric affixed to Vests or |
| | Work Apparel |
| Affixed to Body Surfaces by | On or imbedded in Work |
| Adhesive Contact | Boots, Belts or Vests |
| Affixed to Body Surfaces by | On or imbedded in Work |
| implanted Electrodes | Apparel |
| Imbedded in uniforms | Military, Police, Flight, etc. |
| Imbedded in shirts, formal, | |
| and informal apparel | |
| Imbedded in Expandable | Integrated in with Required |
| Wear Vests or Garments and | Wearable Ancillary |
| Affixed to Body Surfaces by | Equipment such as Self |
| Fabric Tension | Rescuers, Mine Lights, Etc. |

### Physiological Monitoring

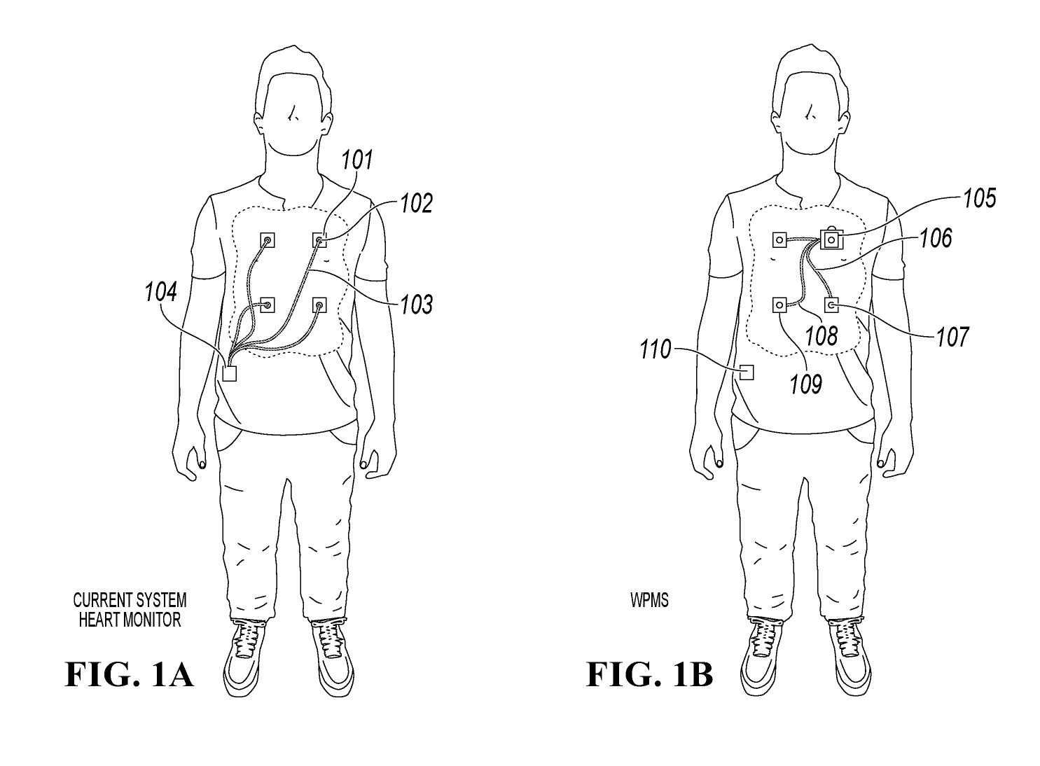

FIG. 1A illustrates a conventional 4-lead continuous heart rate monitor, with electrodes (102) in contact with the skin and affixed by adhesives (101). Each electrode is connected by a wire (103) to a belt-worn device (104) which continuously processes, records, stores, and transmits an electro-cardiogram via, for example, cellular network or the like. FIG. 113 further illustrates a version of the exemplary WPMS system for industrial applications that is wireless. Electrodes (107) are similarly placed with adhesives (109) to be in direct contact with the body or are imbedded in, for example, a wearable stretch fabric vest, strap, or shirt. Each electrode is connected by wire (106) to the electrode with the imbedded wireless transmitter (Recessed Reflector Antenna) (105). The transmitter is configured to transfer data wirelessly to, for example, the belt worn device (110), hand-held device, mobile device, or device imbedded in work apparel (all devices also store data), which then transmits the eco-cardiogram via cellular network, or wirelessly to the Industrial Network System.

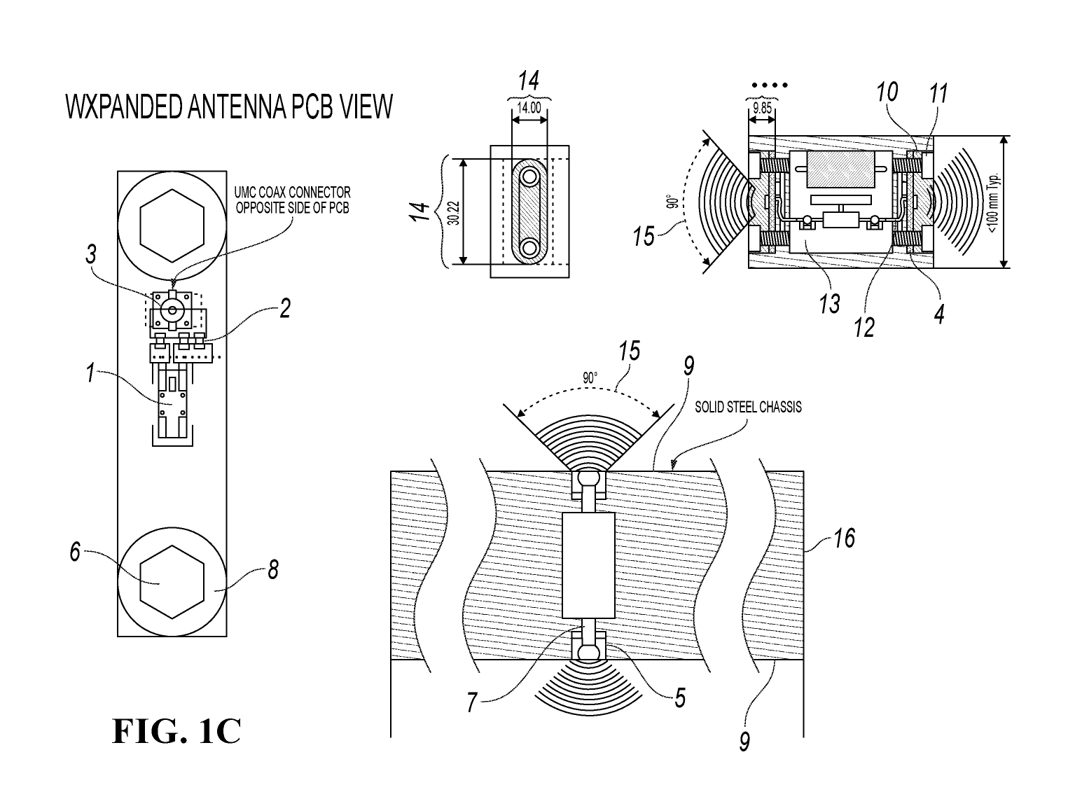

FIG. 2 illustrates another embodiment wherein two closely spaced electrodes or micro-acoustic sensors (201) are affixed to the body via, for example, an adhesive, embedded electrode, or embedded in a wearable stretch fabric vest or strap or shirt, which incorporates an imbedded wireless transmitter (Recessed Reflector Antenna) that transmits heart rate information to a belt worn device (203). The belt worn device (203) includes, for example, a processor, storage, and transmissions system that transmit data via cellular or wireless network to, for example, a hand-held device, cell phone, wearable device (e.g. Wearable watch) or a device imbedded in work apparel. The exemplary WPMS system provides a warning to the wearer or to a central monitoring location, that the wearer's heart rate is irregular since many people that are asymptomatic to heart irregularities do not readily recognize when their heart is out of rhythm (atrial fibrillation, for example).

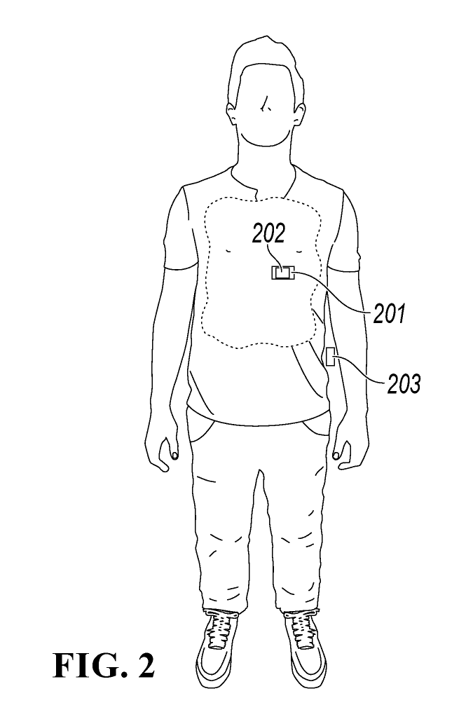

FIG. 3 illustrates another embodiment rein electrode(s) or micro-acoustic sensors (302) are imbedded in a hard-hat (300) and are configured to make contact with the skin to monitor heart rate. The electrode(s) or micro-acoustic sensors 308 are wired (303) to the imbedded wireless transmitter (Recessed Reflector Antenna) 304 mounted on the hard hat (300).

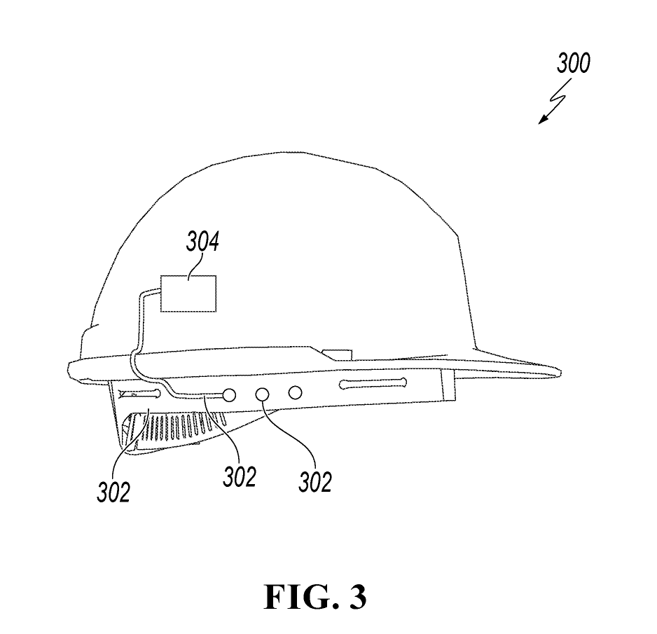

FIG. 4 illustrates another embodiment wherein physiological sensors (401) are embedded into a wearable vest (400). In a typical embodiment, the wearable vest (400) is made of expandable fabric and is in direct contact with the body surface. These physiological (401) sensors coupled with accelerometers or radar (402) to monitor impact and body position, including relative movement, and location, are either wired and connected to a transmitter or imbedded directly with individual transmitters (Recessed Reflector Antenna). The information collected is transmitted to a processor that is, for example, belt worn (405), integrated into PPE, or embedded into the wearable vest itself. The processor, which also stores data, (405) is configured to transmit data using wireless or cellular node networks to a central monitoring location (406) and provides warnings to the wearer and transmits to embedded micro-acoustic speakers or sirens (407) in the vest (400), wearable devices (403), or hand-held devices (404). In some embodiments, the wearable vest (400) may be an outer garment such as, for example, a T-shirt, work apparel, or uniform (law enforcement, or military). The wearable vest (400) may be embedded with physiological sensors such as, for example, micro-acoustic sensors (401) that are configured to monitor heart rate and respiratory function without being in direct contact with the body surface.

The wearable vest (400) may be embedded with at least one of accelerometers and radar for monitoring body movement or impact which are wired and connected to a transmitter. In some embodiments, the transmitters are imbedded directly with individual sensors (all incorporated in the “vest” (400)) and are configured to transmit wirelessly to a cellular gateway, wearable device, hand-held, and the like. In one embodiment the physiological information is transmitted via cellular network to a dispatch or control station for monitoring. Embedded micro-acoustic micro-phones (407) may provide a means of warning personnel of heart and respiratory symptoms, or symptoms that reflect sleeping, attention deficit, or rapid movement, or change in body position

In various embodiments, the electrodes (107, 201, 302, 401, and 402) are sensors that may be configured to detect multiple biometric parameters such as body surface or core temperature, pulse rate, blood pressure, or respiratory functions such as micro-acoustic sensors, hydration, impact, and location/proximity. Pursuant to the other embodiments these sensors could be mounted in direct contact with the body surface through adhesive or embedded in stretchable fabric to maintain between the sensor or the body, imbedded in wearable work garments, or integrated into PPE such as hard-hats. Transmitters (Recessed Reflector Antenna) are mounted on the hard-hat or other PPE, or work garments, or incorporated directly into sensors, or other required wearable equipment such as mine lamps or self-rescuers.

### Environmental Monitoring

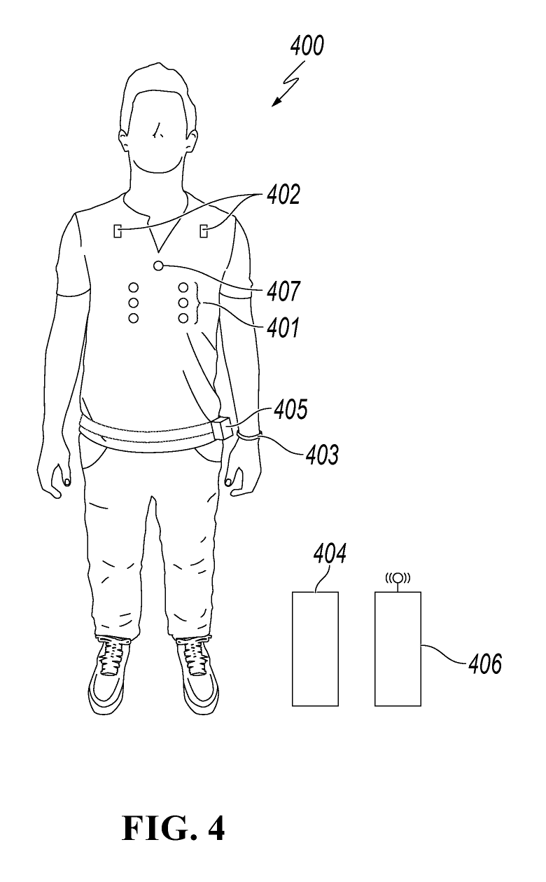

FIG. 5 illustrates various sensors for environmental monitoring. In a typical embodiment, the sensors may be, for example, noise exposure sensors, gas exposure sensors, dust exposure sensors, radiation exposure sensors, or radar, (501) mounted on the surfaces or integrated into a hard-hat (500). The sensors (501) may be coupled with numerous other sensors in the hard-hat (500). These sensors (501) are either coupled with transmitters (Remote Recessed Reflector Antenna) or are wired to a separate transmitter mounted on the hard-hat. Data is transmitted to a processor (502) which may be, for example, belt wearable, hand-held, or imbedded in work apparel. This processor (502), which also stores data, includes a transmitter (Remote Recessed Reflector Antenna) for relaying exposure information to a central monitoring network via cellular or wireless communication, or issue warnings to the wearer via embedded micro-acoustic speakers or sirens, wearable, or hand-held devices.

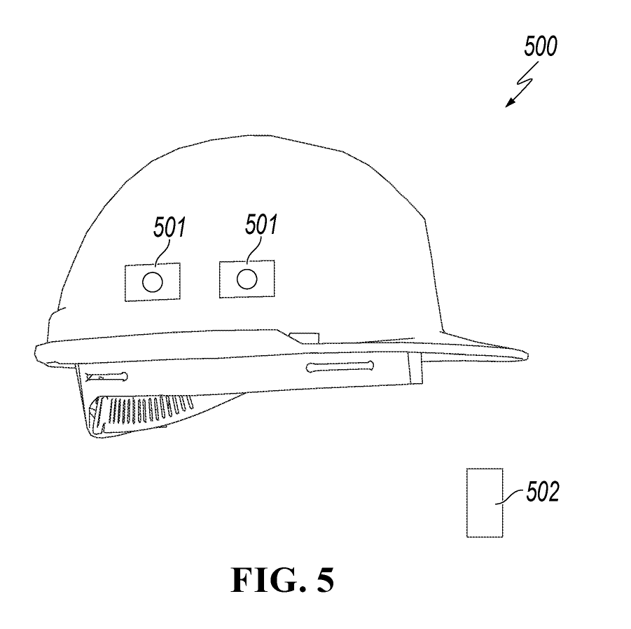

FIG. 6 illustrates another embodiment wherein various sensors for environmental monitoring. In a typical embodiment, the sensors may be, for example, gas exposure sensors, radiation exposure sensors, temperature exposure sensors, dust exposure sensors, noise exposure sensors, proximity sensors, and the like. The sensors are integrated directly into work apparel worn by individuals (600) working in Heavy Industry. Sensors are integrated in a reflective vest (601) as an array into reflective fabric (602) or in coveralls (603). Sensors are positioned depending on hazards, in work boots for H2S detection (604 and 605), and integrated with transmitters (Remote Recessed Reflector Antenna) to a processor, and a transmitter that is either belt worn (605), integrated into PPE, hand-held (608), wearable (607), or integrated in with the sensor arrays embedded into the reflective wear (602 and 603). The processor is configured to store and transmit information to a central monitoring location using, for example, a wireless or cellular network (609). Program logic provides warning on wearable (607) or hand-held devices (608) or embedded warning micro-acoustic speakers or sirens in the hard-hat or reflective fabric (602), or into earpieces/plug: or hard-hat (PPE).

### Location and Proximity Monitoring

The data from the accelerometers and gyroscopes (IMU's) radar sensors, either imbedded in at least one of the hard-hat (500), the wearable work vest (601), or work apparel including reflective fabric on work vests (the WPMS), is used to track a relative position of individuals working in Heavy Industry to a fixed location in the work-place. Proximity information from equipment operating in the work-place such as, for example, mining equipment, construction equipment, and the like is available from equipment mounted sensors or fixed radar nodes which transmit data to a central processing and control center. Program logic incorporates information from the WPMS and the equipment based sensors and determines proximity of personnel to equipment or hazardous locations. Warnings are transmitted from the central processing and control center to personnel that are in the proximity of equipment or hazards, and to operators of such equipment.

### Transmission of Data

Data from physiological and exposure sensors in the exemplary WPMS is transmitted via, for example, the Remote Recessed Reflector Antenna to at least one of a wearable processor, a central monitoring location, a wearable device, and a hand--held device. Data from a wearable processor, which also stores data, is transmitted similarly using the Remote Recessed Reflector Antenna to at least one of a wearable processor, a central monitoring location, a wearable device, and a hand-held device.

Transmission of data is accomplished by use of recessed antennas mounted in conjunction with the sensors in the exemplary WPMS or connected to the sensors by wire and integrated into a hard--hat or imbedded in apparel. The antenna may be encapsulated or otherwise covered with materials that withstand moisture and the environment that individuals in Heavy Industry are exposed to. The size of the aperture used for wireless transmission must be minimized to best protect the antenna and associated circuits. One or more antennas may be implemented for this application, based on the need to radiate and receive signals in multiple directions. An example embodiment of remote dual antennas with recessed reflectors is illustrated in FIG. 1B.

An antenna 1, series and shunt tuning components 2 and cable connector 3 are mounted on a circuit board 4 that is positioned in an antenna cavity 5 with two mounting holes 6 aligned with threaded screw holes 7 in a bottom region of the antenna, cavity 5. The bottom sides of the two screw holes 6 in the circuit board 4 have exposed annular rings 8 that are conductively bonded to a steel surface of the bottom region of the cavity 5 using an electrically conductive compound. This conductive joint between a grounded PCB 4 annular rings 8 extends the circuit board 4 ground plane into a steel chassis 16. This overall ground plane acts as the reflector for the antenna. Currently, the antennas are mounted on the edges of flat corner surface reflectors. Mounting the antenna 1 on flat surface corner reflectors is not possible because the surfaces 9 are ‘wear-surfaces’ (the antenna 1 would be immediately destroyed) and the surfaces are contoured such that they have no corners. Recessing the antenna 1 into the surface prevents it from being scraped off the device by rock and other debris.

The antenna 1 and the circuit board 4 are further protected with a cover 10 formed of a material such as, for example, PTFE that fills the cavity 5 in front of the antenna 1 and which is attached by means of two screws 11. Connectors 3 are attached to RE cables 12. RF cables 12 carry signals to and from the transceiver and processing circuit board 13. Dimensions of cavity 14 allow the radiation pattern 15 to he ninety degrees (or greater, by means of altering these dimensions 14, when practical), This set of cavity dimensions 14 is specific to this example and may be altered, as required, for similar embodiments. Recessing the antenna 1 changes the radiation characteristics from an omnidirectional configuration that is characteristic of radiation reflected off a flat reflector to radiation reflected off of a horn antenna. This will make the antenna 1 beam operate in a directional pattern. Because the antennas are mounted on various sensors and incorporated into PPE or work apparel, the signal radiation will deflect off of other objects to disperse to the antenna on the other end of the transmission.

### Early Warning of Developing Hazards

Since the sensors are worn by all personnel in the potentially hazardous areas and have the ability to transmit and receive information wirelessly in a mesh network, activation of a sensor on one person may be passed along local communication networks to warn other personnel in the area of the potential hazard or of the condition or of a person who may be in need of emergency assistance. This capability may lead to faster time-critical responses to personal health needs such as, for example, fainting, heart attacks, and the like. In the event of a pending hazard, such as an increased gas concentration, the warning on one person's sensors may serve to warn all people in the area of the need to evacuate the hazardous area.

Particular embodiments may include one or more computer-readable storage media implementing any suitable storage. In particular embodiments, a computer-readable storage medium implements one or more portions of the processor, one or more portions of the system memory, or a combination of these, where appropriate. In particular embodiments, a computer-readable storage medium implements RAM or ROM, In particular embodiments, a computer-readable storage medium implements volatile or persistent memory. In particular embodiments, one or more computer-readable storage media embody encoded software.

Exemplary embodiments also relate to a non-invasive, wearable device to monitor, for example, canine vital signs, activity, and location using sensors embedded in, for example, a canine-worn vest or canine-worn collar. In a typical embodiment, the canine-worn vest also serves as an Ultra Violet (UV) protectant, or climate-control vest. The exemplary system provides minimum functionality if isolated and provides an expanding range of feedback if coupled with, for example, a drone, a communications node, a handler or any combination thereof. In a typical embodiment, the exemplary system is configured to monitor body attributes such as, for example, body temperature, heart rate, respiration, hydration level in addition to body position and location to provide the handler with an accurate assessment of the canine's physiology. In some situations, it may also be feasible to gather intelligence and collect special data in the vicinity of the canine. Implementation of a cellular network may further allow monitoring of multiple canine units simultaneously.

### Recording Canine Data:

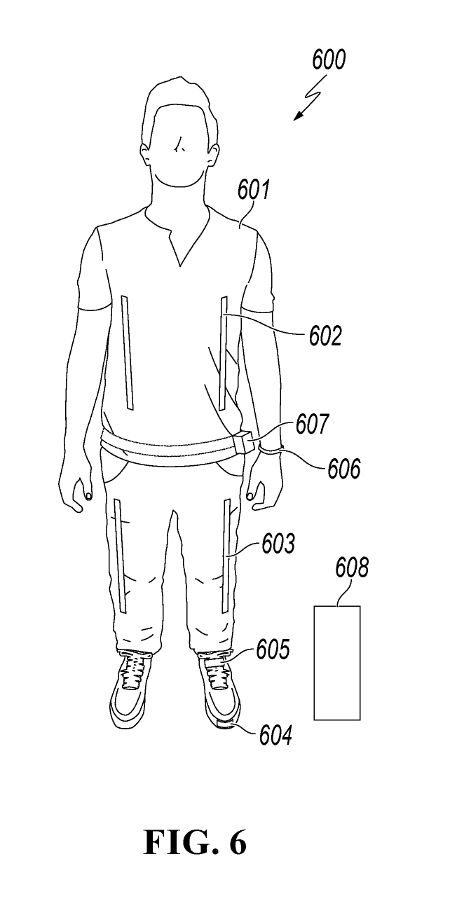

FIG. 7 illustrates an exemplary physiological and environmental monitoring system. In a typical embodiment, the system is mounted in a canine-worn collar or harness. Monitoring the vital signs of canines includes, for example, surface body temperature, heartbeat frequency, respiration, hydration levels, and the like. The vital signs may be monitored via sensors mounted within a wearable vest 701. Surface body temperature may be measured using a combination of, for example, an ambient temperature sensor and IR LED and detector pair 702. Heartbeat and respiration frequency may be measured using, for example, a microphone array 703 as a primary means of detection and ultra-wideband radar 704 as a secondary means. Hydration levels may be measured using, for example, a form of pressure feedback via small servo 705 with encoder feedback.

### Body Position, Location and Environment:

Canine body position and activity (e.g., standing, sitting, laying, climbing, etc.) may be determined through a correlation of data from at least two inertial measurement units (IMU's) 706 mounted in different locations on the wearable vest 701. Physical location may be monitored using, for example, a Global Positioning System (GPS) 707 as a primary means, MU 708 data as a secondary means, and at least one of radar and LiDAR 709 as a tertiary means. In some embodiments, video may streamed via a camera 710 mounted on the wearable vest 701 in order to record events and increase the handler's visualization. Gas sensors 711 mounted on the wearable vest 701 are configured to provide information about potential hazards. A micro--speaker 712 mounted on the wearable vest 701 allows for audible warnings or commands to be communicated to the canine.

### Communications Network:

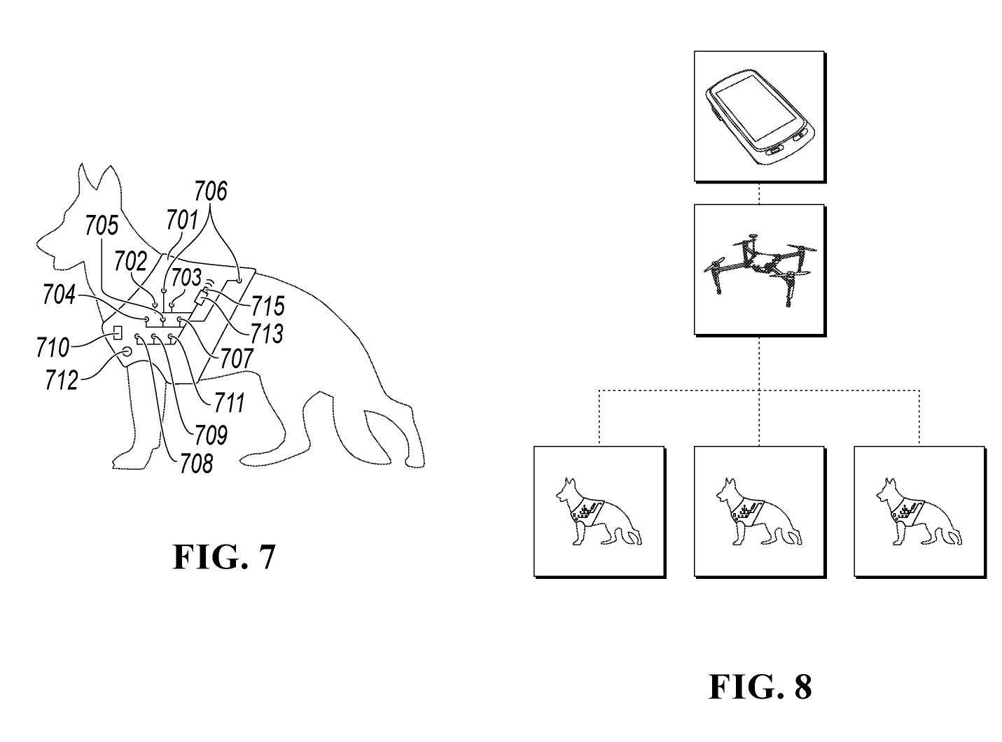

The various sensors disclosed above are configured to communicate with a printed circuit board (PCB) 713 using wires 714 embedded in the wearable vest 701. Data processed by the PCB 713 is wirelessly transmitted via a recessed radio antenna 715 described below to a drone. The drone is configured to relay the data to a receiver such as, for example, a handheld device used by the handler. In various embodiments, several of these canine units may act as mesh clients in a wireless mesh network (WMN), as illustrated in FIG. 8. The wireless mesh network is self-healing and self-forming, using, for example, IEEE 802.15.4 standard which specifies the physical layer and media access control for low-rate wireless personal area networks (LR-WPANs). In a typical embodiment, a cellular 802.15.4/802.11 communications node also acts as a gateway for the WMN. Alternatively, the PCB 713 may be in communication with a network described in U.S. provisional patent application 62/492,361 entitled “Method and System for Monitoring the Condition of Nuts and Bolts,” and incorporated herein by reference via a recessed radio antenna 715.

From the perspective of monitoring canine physiology and its surrounding environment, the wearable vest 701 is considered to be remote since there are no practical means to attach wires for communication. Sending the signals to the handler is a challenge. For the physiological and environmental monitoring system, the monitoring electronics inside the wearable vest 701 are typically battery powered.

Transmission of data is accomplished via, for example, recessed antennas mounted in the surface of the wearable vest 701. The size of the aperture used for wireless transmission is minimized to best protect the antenna and associated circuits. According to exemplary embodiments, one or more antennas may be implemented based on a need to radiate and receive signals in multiple directions as described above with respect to FIG. 1C.

In this patent application, reference to encoded software may encompass one or more applications, bytecode, one or more computer programs, one or more executables, one or more instructions, logic, machine code, one or more scripts, or source code, and vice versa, where appropriate, that have been stored or encoded in a computer-readable storage medium. In particular embodiments, encoded software includes one or more application programming interfaces (APIs) stored or encoded in a computer-readable storage medium. Particular embodiments may use any suitable encoded software written or otherwise expressed in any suitable programming language or combination of programming languages stored or encoded in any suitable type or number of computer-readable storage media. In particular embodiments, encoded software may be expressed as source code or object code. In particular embodiments, encoded software is expressed in a higher-level programming language, such as, for example, C, Python, Java, or a suitable extension thereof. In particular embodiments, encoded software is expressed in a lower-level programming language, such as assembly language (or machine code). In particular embodiments, encoded software is expressed in JAVA. In particular embodiments, encoded software is expressed in Hyper Text Markup Language (HTML), Extensible Markup Language (XML), or other suitable markup language.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

1. A system comprising:
a sensor, the sensor comprising:
an electrode embedded in a wearable garment; and
a first transmitter;
a processing unit, the processing unit comprising:
a receiver that receives information from the first trans relating to at least one of a physiological and an environmental condition of an individual wearing the garment; and
a second transmitter that provides the information to a central monitoring location.

2. The system of claim 1, wherein the individual is a human worker.

3. The system of claim 2, wherein the processing unit provides a warning to the human worker responsive to at least one of the physiological and environmental conditions exceeding safe threshold.

4. The system of claim 2, wherein the wearable garment s a vest.

5. The system of claim 2, wherein the wearable garment is a hard hat.

6. The system of claim 1, wherein the individual is a K9 unit.

7. The system of claim 1, wherein the processing unit is embedded in the wearable garment.
